(19) United States
(12) Patent Application Publication
(10) Pub. No.: US 2006/0146269 A1
(43) Pub. Date: Jul. 6, 2006

(54) TFT substrate and manufacturing method of the same

(76) Inventor: Kyung-wook Kim, Seoul (KR)

Correspondence Address: CANTOR COLBURN, LLP, 55 GRIFFIN ROAD SOUTH, BLOOMFIELD, CT, 06002, US

(21) Appl. No.: 11/327,203

(22) Filed: Jan. 5, 2006

(30) Foreign Application Priority Data
Jan. 5, 2005 (KR) 2005-0000770

(51) Int. Cl. G02F 1/1333

(52) U.S. Cl. 349/158

(57) ABSTRACT

A TFT substrate comprising a TFT comprises a drain electrode; a first passivation film formed on the TFT; a second passivation film formed on the first passivation film and having lower resistivity than the first passivation film; and a pixel electrode formed on the second passivation film and comprising a first pixel area electrically connected to the drain electrode and a second pixel area electrically separated from the drain electrode and the first pixel area. Thus, the present invention provides a TFT substrate efficiently discharging electric charges accumulated in a pixel when electric power is off.

This application claims priority to Korean Patent Application No. 2005-0000770, filed on Jan. 5, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a TFT substrate and a manufacturing method of the same, and more particularly, the present invention relates to a TFT substrate and a manufacturing method of the same which efficiently discharges electric charges accumulated in a pixel by lowering resistivity of a passivation layer contacting with a pixel electrode.

2. Description of the Related Art

A liquid crystal display (LCD) includes an LCD panel comprising a TFT substrate where TFTs are formed, a color filter substrate where color filters are formed, and a liquid crystal layer interposed between both substrates. The LCD panel does not emit light by itself, therefore there is disposed a backlight unit at a rear of the TFT substrate to provide light. Transmittance of the light from the backlight unit is adjusted according to an alignment of the liquid crystal layer.

The LCD has advantages of being slim and small-sized, and low-consuming electric power. However, the LCD is hard to be made big-sized, to realize full color, to enhance contrast, and to have wide viewing angle.

A patterned vertically aligned (PVA) mode is a mode for improving the viewing angle and has cutting patterns on a pixel electrode and a common electrode, respectively. The viewing angle is enhanced by adjusting a lying direction of liquid crystal molecules using fringe field formed by those cutting patterns.

The liquid crystal molecules in the PVA mode behaves perpendicularly, therefore difference between phase retardation values of light passing through the liquid crystal molecules when being observed in a front side and a lateral side may vary depending on the viewing angle. Accordingly, brightness of low gray scale in the lateral side rapidly rises, thereby causing acknowlegement quality to lower along with lowering contrast ratio. To solve this disadvantage, a super-PVA (SPVA) mode has been developed, in which the pixel electrode is divided into two areas, a first area where the data voltage is directly applied and a second area which is floated electrically.

Meanwhile, a ground voltage is applied through the gate line when the LCD panel is off, accordingly it is applied to the gate electrode of the TFT as well. In this case, as electric current of 10 pA˜1 nA may flow through the TFT, electric charges charged in the pixel are all discharged to the outside through the data line. If the electric charges are not properly discharged, voltages having the same polarity are continually applied to the liquid crystal, therefore afterimages are still on the LCD panel after the LCD panel is off, or flicker is generated when the LCD panel is on.

However, the second area of the SPVA is under the floating condition which is not electrically connected to the first area, the TFT, and the data line, therefore electric charges accumulated in the second area are not properly discharged when the LCD panel is off.

### BRIEF SUMMARY OF THE INVENTION

Accordingly, it is an aspect of the present invention to provide a TFT substrate efficiently discharging electric charges accumulated in a pixel when electric power is off.

Another aspect of the present invention is to provide a manufacturing method of a TFT substrate efficiently discharging electric charges accumulated in a pixel when electric power is off.

Further, the present invention also provides an LCD panel including a TFT substrate efficiently discharging electric charges accumulated in a pixel when electric power is off.

The foregoing and/or other aspects of the present invention are achieved by providing a TFT substrate comprising a TFT comprising a drain electrode; a first passivation film formed on the TFT; a second passivation film formed on the first passivation film and having lower resistivity than the first passivation film; and a pixel electrode formed on the second passivation film and comprising a first pixel area electrically connected to the drain electrode and a second pixel area electrically separated from the drain electrode and the first pixel area.

Accordingly to an exemplary embodiment of the present invention, a portion of the drain electrode overlaps with the second pixel area, having the first passivation film and the second passivation film therebetween.

Accordingly to an exemplary embodiment of the present invention, the first passivation film and the second passivation film are made of silicon nitride, and the second passivation film has a higher silicon content than the first passivation film.

Accordingly to an exemplary embodiment of the present invention, the resistivity of the second passivation film is 1/100˜ 1/1000 of the resistivity of the first passivation film.

Accordingly to an exemplary embodiment of the present invention, the resistivity of the second passivation film is 10¹¹ Ωcm˜10¹² Ωcm.

Accordingly to an exemplary embodiment of the present invention, a thickness of the first passivation film is 1000 Å˜3000 Å and a thickness of the second passivation film is 100 Å˜500 Å.

The foregoing and/or other aspects of the present invention are also achieved by providing a manufacturing method of a TFT substrate comprising forming a TFT comprising a drain electrode; forming a first passivation film and a second passivation film having lower resistivity than the first passivation film, on the TFT sequentially; and forming a pixel electrode on the second passivation film, the pixel electrode comprising a first pixel area electrically connected to the drain electrode and a second pixel area electrically separated from the drain electrode and the first pixel area.

Accordingly to an exemplary embodiment of the present invention, the second passivation film is formed by chemical vapor deposition of silicon source gas and nitrogen source gas.

Accordingly to an exemplary embodiment of the present invention, the first passivation film and the second passivation film are formed by chemical vapor deposition of silicon source gas and nitrogen source gas.

Accordingly to an exemplary embodiment of the present invention, the first passivation film and the second passivation film are formed successively.

Accordingly to an exemplary embodiment of the present invention, a flow rate of the silicon source gas of the forming the second passivation film is 1.5 times˜3 times of a flow rate of the forming the first passivation film.

Accordingly to an exemplary embodiment of the present invention, a flow rate of the nitrogen source gas of the forming the second passivation film is 0.1 times˜0.5 times of a flow rate of the forming the first passivation film.

Accordingly to an exemplary embodiment of the present invention, the first passivation film and the second passivation film are formed by a plasma enhanced chemical vapor deposition, and high-frequency power frequency of the forming the second passivation film is lower than high-frequency power frequency of the forming the first passivation film.

Accordingly to an exemplary embodiment of the present invention, the high-frequency power frequency of the forming the second passivation film is 0.1 times˜0.5 times of the high-frequency power frequency of the forming the first passivation film.

Accordingly to an exemplary embodiment of the present invention, the silicon source gas comprises silane gas, and the nitrogen source gas comprises ammonia gas.

The foregoing and/or other aspects of the present invention are also achieved by providing an LCD panel comprising a first substrate comprising a TFT having a drain electrode, a first passivation film formed on the TFT, a second passivation film formed on the first passivation film and having lower resistivity than the first passivation film, and a pixel electrode formed on the second passivation film and having a first pixel area electrically connected to the drain electrode and a second pixel area electrically separated from the drain electrode and the first pixel area; a second substrate facing the first substrate; and a liquid crystal layer disposed between the first substrate and the second substrate.

Accordingly to an exemplary embodiment of the present invention, the second substrate comprises a common electrode where a common electrode cutting pattern is formed.

Accordingly to an exemplary embodiment of the present invention, the liquid crystal layer is vertical alignment mode.

Accordingly to an exemplary embodiment of the present invention, a discharging amount of the second pixel area is less than 20% of a charging amount thereof in one frame.

Accordingly to an exemplary embodiment of the present invention, the charging amount of the second pixel area is discharged 90% or more within 500 ms when the electric power is off.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIGS. 1a and 1b are drawings of an exemplary embodiment to illustrate an arrangement of an LCD panel according to the present invention;

FIG. 2 is a sectional view of FIG. 1a, taken along line II-II;

FIG. 3 is a drawing of the exemplary embodiment to show a principle of improving acknowledgement quality of the LCD panel according to the present invention;

FIG. 4 is an equivalent circuit diagram of the exemplary embodiment of a pixel according to the present invention;

FIGS. 5a through 5f are drawings of the exemplary to illustrate a manufacturing method of a TFT substrate according to the present invention; and

FIG. 6 is a drawing of a plasma device used for forming a passivation film.

### DETAILED DESCRIPTION OF THE PREFERRED EMBODIMENT

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

It will be understood that when an element such as a layer, film, region, or substrate is referred to as being “on” another element, it can be directly on the other element or intervening elements may also be present.

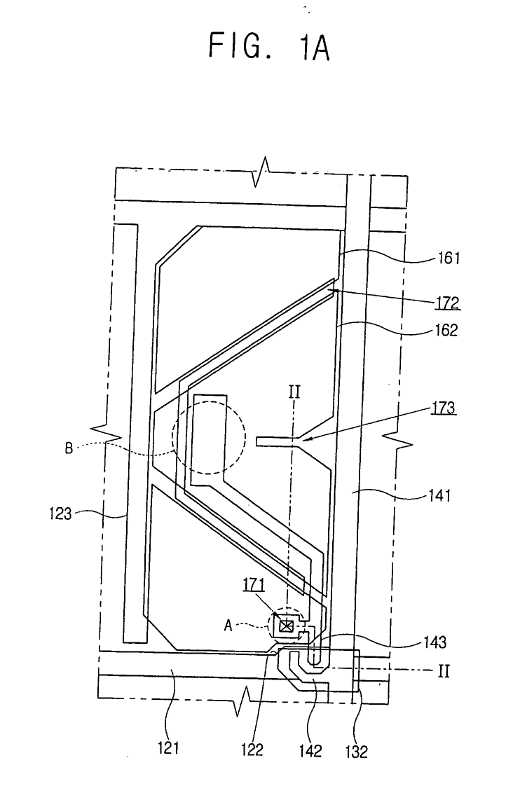

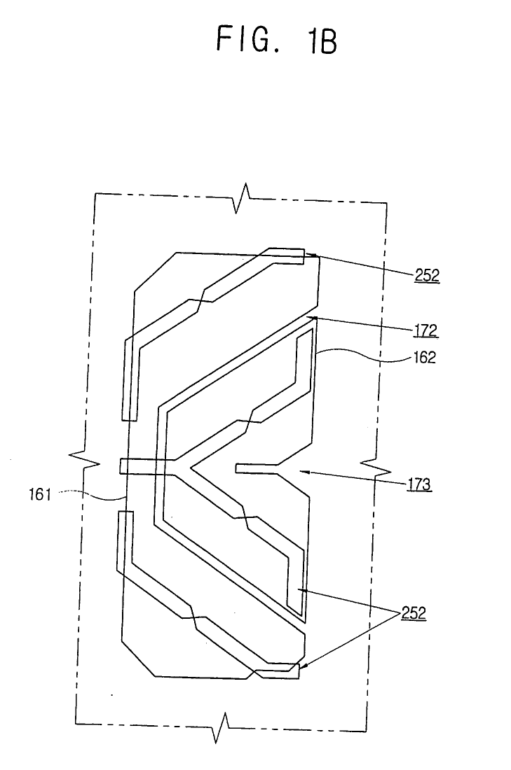

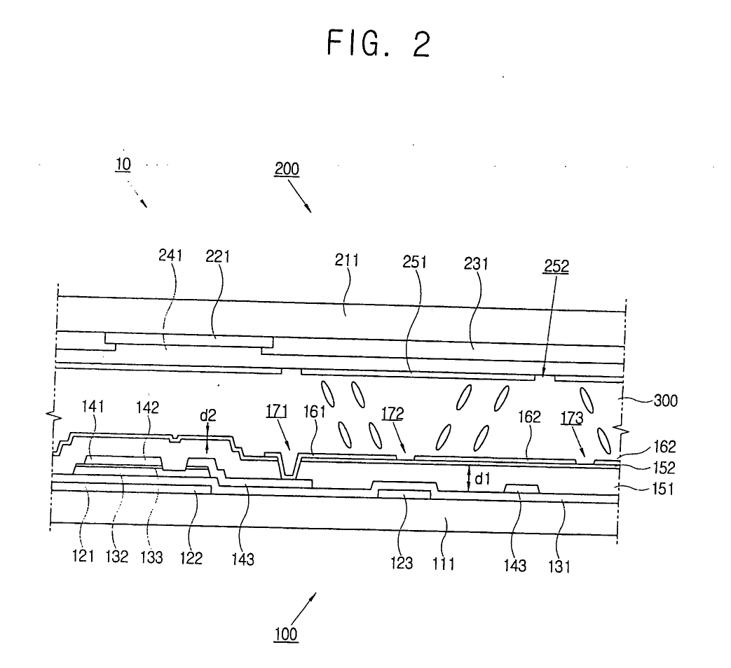

FIGS. 1a and 1b are drawings of an exemplary embodiment to illustrate an arrangement of an LCD panel 10 according to the present invention; and FIG. 2 is a sectional view of FIG. 1a, taken along line II-II. More specifically, FIG. 1a is a drawing to show an arrangement of a TFT substrate 100, and FIG. 1b is a drawing to show a pixel electrode 161,162 of the TFT substrate 100 and a common electrode cutting pattern 252 formed on a common electrode 251 of a color filter 200.

The LCD panel 10 according to the exemplary embodiment of the present invention includes the TFT substrate 100 (first substrate), the color filter substrate 200 (second substrate) facing the TFT substrate 100, and a liquid crystal layer 300 interposed therebetween.

First, the TFT substrate 100 will be described as following.

A gate line assembly 121,122,123 is formed on a first insulating substrate 111. The gate line assembly may be a metal single-layer or a metal multi-layer. The gate line assembly 121,122,123 includes a gate line 121 extended horizontally, a gate electrode 122 connected to the gate line 121, and a common electrode line 123 overlapping with the pixel electrode 161,162 to form storage capacitance.

A gate insulating layer 131 made of silicon nitride (SiNx) is disposed on the first insulating layer 111 to cover the gate assembly line 121,122,123.

A semiconductor layer 132 made of amorphous silicon is formed on the gate insulating layer 131 of the gate electrode 122. An ohmic contact layer 133 is formed on the semiconductor layer 132 and made of n+ hydrogenated amorphous silicon which is highly doped with silicide or n− type impurities. The ohmic contact layer 133 is removed from a channel area between the source electrode 142 and the drain electrode 143.

A data assembly line 141,142,143 is formed on the ohmic contact layer 133 and the gate insulating layer 131. The data assembly line 141,142,143 is a metal single-layer or a metal multi-layer as well. The data assembly line 141,142,143 includes a data line 141 extended vertically and crossing the gate line 121 to define a pixel, a source electrode 142 branched from the data line 141 and extended over the ohmic contact layer 133, and a drain electrode 143 separated from the source electrode 142 and formed on the ohmic contact layer 133 opposite to the source electrode 142. Here, the drain electrode 143 includes an area A electrically contacting with a first pixel area 161 and an area B lengthwise extended to a lower part of a second pixel area 162.

A passivation films 151,152 are formed on the data line assembly 131,132,133 and the semiconductor layer 132 which is not covered with the data assembly line 131,132,133. A contact hole 171 is formed on the passivation films 151,152 to expose the drain electrode 143. The passivation films 151,152 are divided into a lower first passivation film 151 and an upper second passivation film 152 contacting with the pixel electrode 161,162. A thickness d1 of the first passivation film 151 is 100 Å˜3000 Å, and a thickness d2 of the second passivation film 152 is 100 Å˜500 Å. The first passivation film 151 and the second passivation film 152 are formed of silicon nitride, wherein the second passivation film 152 has a higher silicon content than the first passivation film 151. Resistivity of the second passivation film 152 is lower than resistivity of the first passivation film 151. Preferably, the resistivity of the second passivation film 152 is 1/10˜ 1/1000 of the resistivity of the first passivation film 151. Specifically, the resistivity of the second passivation film 152 is 10¹¹ Ωcm-10¹² Ωcm, in this case, the first passivation film 151 substantially functions as an insulating layer. The function of the second passivation film 152 will be mentioned later.

The pixel electrode 161,162 is formed on the second passivation film 152. The pixel electrode 161,162 is typically formed of indium tin oxide (ITO) or indium zinc oxide (IZO). The pixel electrode 161,162 is divided into the first pixel area 161 contacting with the drain electrode 143 through the contact hole 171 and the second pixel area 162 electrically separated from the first pixel area 161 and the drain electrode 143. The first pixel area 161 is separated from the second pixel area 162 by a pixel electrode cutting pattern 172 and the second pixel area 162 includes a pixel electrode cutting pattern 173 formed thereon. A portion B of the drain electrode 143 is disposed in the lower part of the second pixel area 162 having the passivation films 151,152 therebetween.

The pixel electrode cutting patterns 172,173 of the pixel electrode 161,162, along with the common electrode cutting pattern 252, divide the liquid crystal layer 300 into a plurality of areas.

Next, the color filter substrate 200 will be described.

A black matrix 221 is formed on a second insulating substrate 211. The black matrix 221 is disposed between a red, a green, and a blue filters to divide the filters, and prevents light irradiating directly to the TFT disposed on the first substrate 100. The black matrix 221 is typically made of photoresist organic substance containing a black pigment. The black pigment may be carbon black, titanium oxide, or the like.

A color filter layer 231 includes a red, a green, and a blue filters which are repeatedly disposed by confining with the black matrix 221. The color filter layer 231 invests light irradiated from the backlight unit and passing through the liquid crystal layer 300 with colors. The color filter layer 231 is typically made of photoresist organic substance.

An overcoat layer 241 is formed on the color filter layer 231 and the black matrix 221 which is not covered with the color filter layer 231. The overcoat layer 241 protects the color filter layer 231 while planarizing the color filter layer 231. The overcoat layer 241 is typically formed of acrylic epoxy material.

The common electrode 251 is formed on the overcoat layer 241. The common electrode 251 is made of ITO or IZO. The common electrode 251, along with the pixel electrode 161,162 of the TFT substrate, applies voltage to the liquid crystal layer 300. The common electrode cutting pattern 252 is formed on the common electrode 251. The common electrode cutting pattern 252 divides the liquid crystal layer 300 into a plurality of areas along with the pixel electrode cutting patterns 172,173 of the pixel electrode 161,162.

The pixel electrode cutting patterns 172,173 and the common electrode cutting pattern 252 may be formed in various shapes.

The liquid crystal layer 300 is disposed between the first substrate 100 and the second substrate 200. The liquid crystal layer 300 is vertically aligned (VA) mode which liquid crystal molecules are aligned vertically when the voltage is not applied. The liquid crystal molecules lie vertically to electric field when the voltage is applied because anisotropic permittivity of the liquid crystal molecules is negative. However, if the patterns 172,173,252 are not formed, the liquid crystal molecules are irregularly aligned according as lying direction of the liquid crystal molecules is not determined, and a disclination line is formed at the boundary where aligning directions are different. The patterns 172,173,252 form fringe field to determine the lying direction of the liquid crystal alignment when the liquid crystal layer 300 is applied with the voltage. Further, the liquid crystal layer 300 is divided into a plurality of areas according to arrangement of the patterns 172,173,252.

The exemplary embodiment may be modified in various ways. For example, the common electrode line 123 is formed in various patterns or the pixel is divided into 3 areas or more.

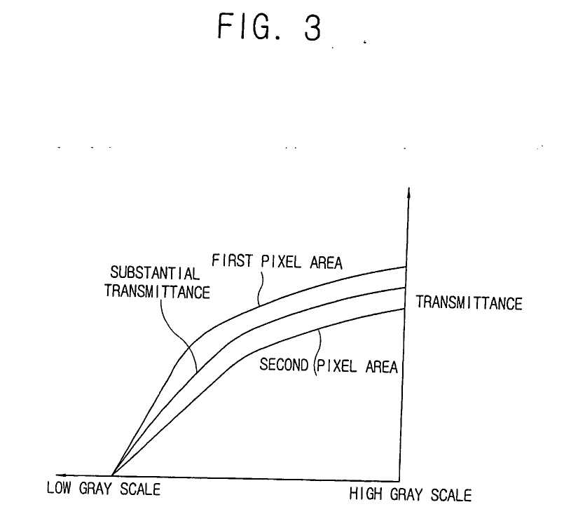

In the following, it will be described why acknowlegement quality is enhanced in the aforementioned LCD panel 10 as referring to FIG. 3.

Light from the backlight unit passes through the first pixel area 161 or the second pixel area 162, the liquid crystal layer 300, and the second substrate 200 to be recognized by a user. The first pixel area 161 is normally applied with a data signal through the drain electrode 143, while the second pixel area is not applied with the data signal directly from the drain electrode 143 but applied the data signal by capacity C_{cp} formed in the passivation films 151,152. Therefore, the second pixel area 162 is applied with a weaker signal than the first pixel area 161, thereby showing lower transmittance of the light at the same data signal. That is, gamma curves becomes different in the first pixel electrode 161 and the second pixel electrode 162, respectively, thereby enhancing lateral-side acknowlegement quality. The transmittance of the light that the user actually senses is an average one between the first pixel area 161 and the second pixel area 162.

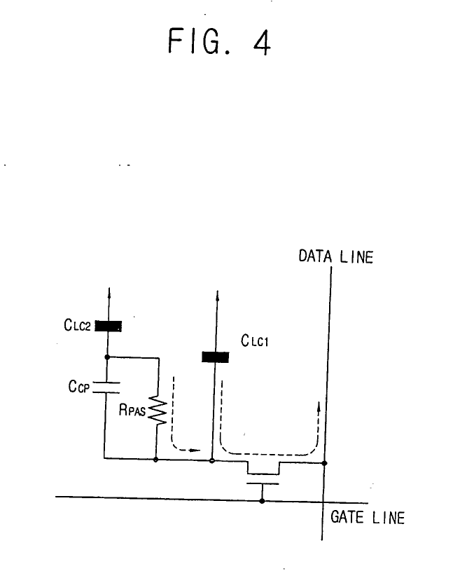

Hereinafter, it is described how the second passivation film 152 functions as referring to FIG. 4 showing an equivalent circuit diagram of the pixel.

Two liquid crystal capacities C_{LC1}, C_{LC2} are connected to the TFT. The first liquid crystal capacity C_{LC1} is directly connected to the TFT, while the second liquid crystal capacity C_{LC2} is connected to the TFT through the passivation film capacity C_{CP}. The first liquid crystal capacity C_{LC1} is capacity formed in the first pixel area 161 and the second liquid crystal capacity C_{LC2} is capacity formed in the second pixel area 162.

If there is not provided the second passivation film 152 apart from the exemplary embodiment, that is, if the pixel electrode 161,162 is formed on the first passivation film 151, the first liquid crystal capacity C_{LC1} is electrically separated from the second liquid crystal capacity C_{LC2}. Under that condition, if a ground voltage is applied to the TFT, the first liquid crystal capacity C_{LC1} is discharged to the outside through the TFT and the data line, while the second liquid crystal capacity C_{LC2} cannot be discharged to the outside.

The second passivation film 152 in the exemplary embodiment has low resistance, therefore resistance R_{PAS} is formed to connect the first liquid crystal capacity C_{LC1} to the TFT, as shown in FIG. 4. Accordingly, the second liquid crystal capacity C_{LC2} is discharged to the outside by the resistance R_{PAS}. In detail, when the TFT is applied with ground electric power, electric charges in the first pixel area 161 are discharged to the outside through the TFT and the data line, while electric charges in the second pixel area 162 transfer to the first pixel area 161 through the second passivation film 152 having the low resistivity and are discharged to the outside. Thus, all the electric charges in the pixel are discharged properly.

Meanwhile, the resistivity of the second passivation film 152 is designed both to discharge electric charges in a short time when the LCD panel 10 is off and to minimize electric charges which transfers from the second pixel area 162 to the first pixel electrode 161 when the LCD panel 10 is on. If the resistivity of the second passivation film 152 is too large, the electric charges are not efficiently discharged when the LCD panel 10 is off. On the other hand, if the resistivity of the second passivation film 152 is too small, the electric charges in the second pixel area 162 transfers to the first pixel area 161 a lot when the LCD panel 10 is on. Accordingly, voltages applied to both pixel areas 161,162 become similar, thereby acknowledgement quality is not enhanced. Preferably, the resistivity of the second passivation film 152 is controlled so that a discharging amount of the second pixel area 162 is less than 20% of a charging amount thereof in a frame and the charging amount of the second pixel area 162 is discharged 90% or more with 500 ms when the electric power is off.

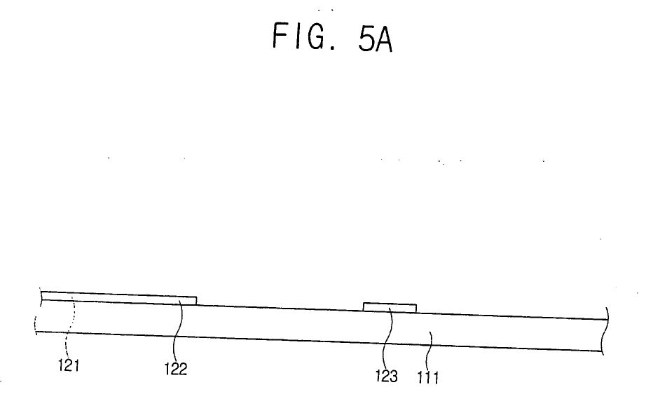

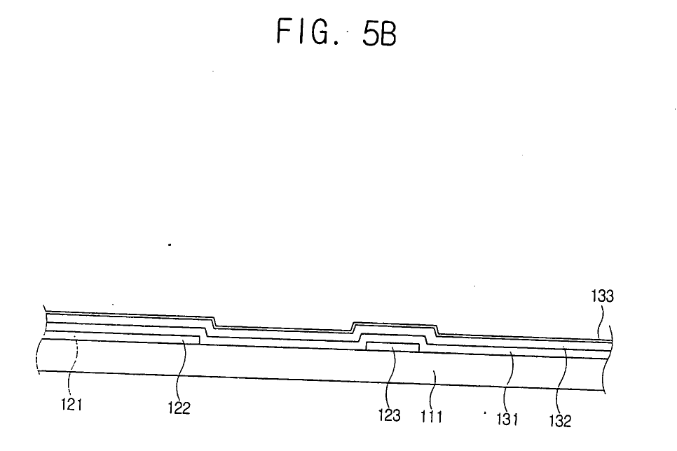

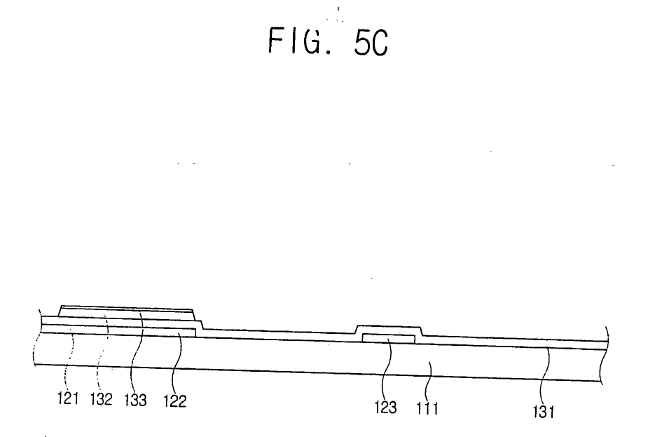

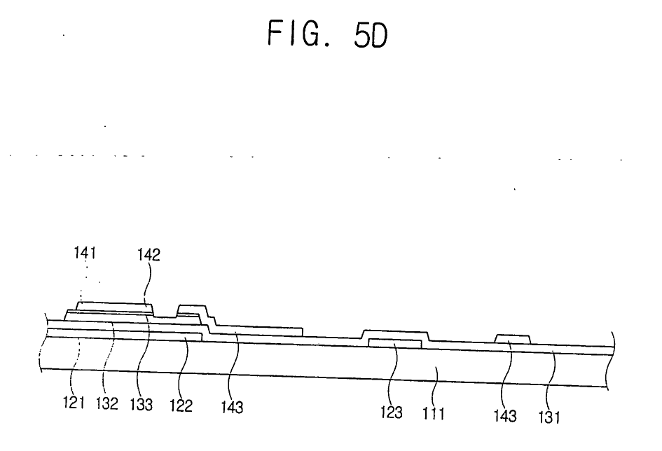

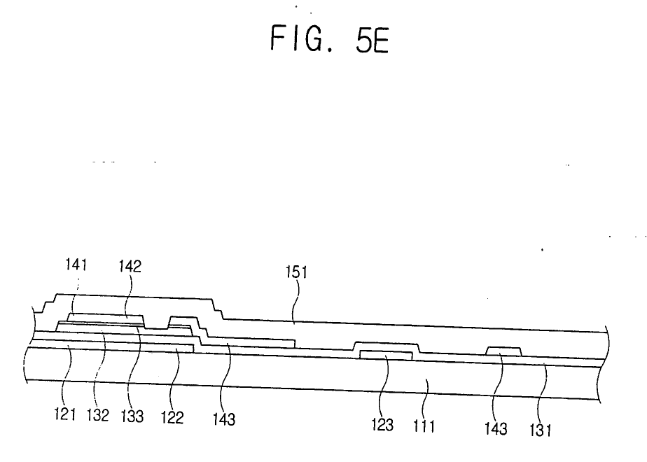

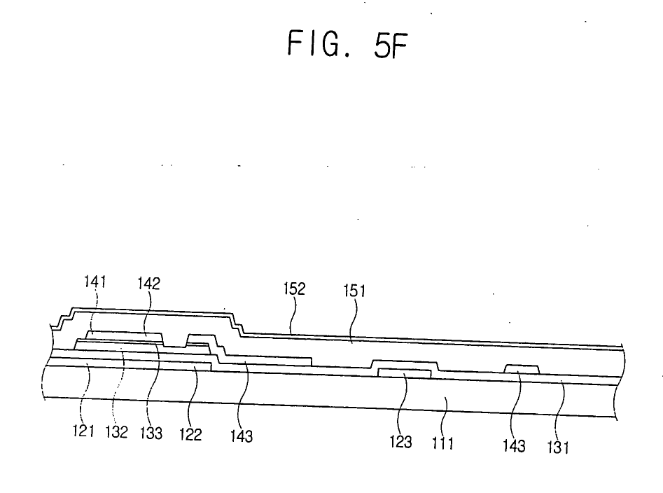

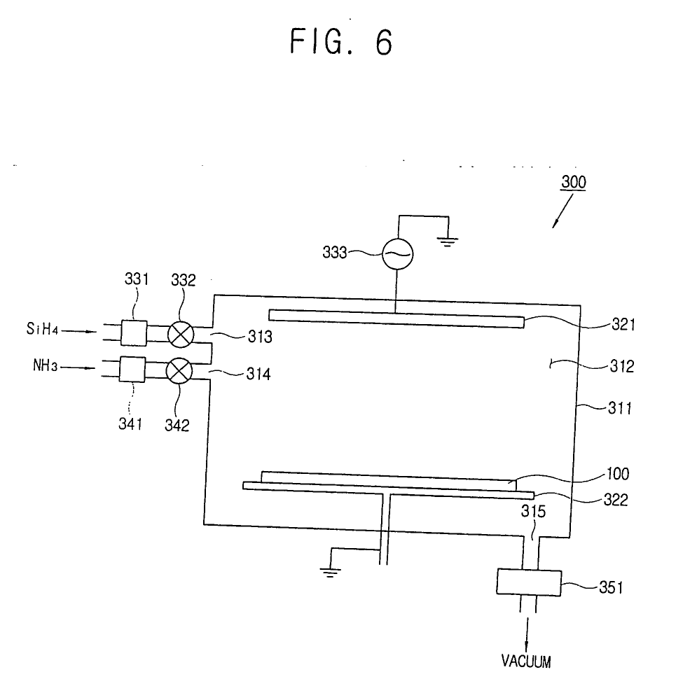

Hereafter, a manufacturing method of the TFT substrate 100 will be described as referring to FIGS. 5a through 5f and FIG. 6.

Referring to FIG. 5a, gate line assembly material is deposited on the first insulating substrate 111 and patterned by photolithography using a mask to form the gate line assembly 121,122,123 including the gate line 121, the gate electrode 122, and the common electrode 123.

Referring to FIG. 5b, the gate insulating layer 131, a semiconductor layer 132, and the ohmic contact layer 133 are sequentially deposited.

Referring to FIG. 5c, the semiconductor layer 132 and the ohmic contact layer 133 are etched by photolithography to be formed in an island shape on the gate insulating layer 131 of the gate electrode 122.

Referring to FIG. 5d, data line assembly material is deposited and patterned by photolithography using the mask to form the data line assembly 141,142,143 including the data line 141 crossing the gate line 121, the source electrode connected to the data line 141 and extended over the gate electrode 122, and the drain electrode 143 opposite to the source electrode 142. Then, the ohmic contact layer 133 which is not covered with the data line assembly 141,142,143 is etched to be divided in two across the gate electrode 122 and to expose the semiconductor layer 132. Here, the drain electrode 143 is extended to the second pixel area 162 which is subsequently formed.

Referring to FIG. 5e, the first passivation film 151 is formed. The first passivation film 151 is formed by a plasma enhanced chemical vapor deposition (PECVD) using silicon source gas and nitrogen source gas.

Here, a plasma device 300 used for forming the first passivation film 151 will be described as referring to FIG. 6.

A process chamber 311 forms a reacting space 312 where plasma is generated. In the reacting space 312 are formed inlets 313,314 into which source gas flows, and an outlet 315 where the source gas used in a reaction and byproduct generated from the reaction are discharged. Further, an upper electrode 321 and a lower electrode 322 in a plate shape are disposed in the reacting space 312. The lower electrode 322 supports the TFT substrate 100 where the data line assembly 141,142,143 is formed. The upper electrode 321 and the lower electrode 322 may be made of an aluminum plate, and the lower substrate 322 is preferably larger than the TFT substrate 100.

In the exemplary embodiment, the silicon source gas is silane gas (SiH₄) and the nitrogen source gas is ammonia gas (NH₄). The silane gas passes through a mass flow controller 331 and a valve 332 and flows into the reacting space 312 through the inlet 313. The ammonia gas passes through a mass flow controller 341 and a valve 342 and flows into the reacting space 312 through the inlet 314. A high-frequency (RF) power is connected to the upper electrode 321. The outlet 315 is connected a vacuum pump 351. The vacuum pump 351 flows the source gas and the byproduct out after the reaction, and keeps the reacting space 312 vacuum properly.

The plasma device 300 uses capacitive coupled plasma, but may use induced coupled plasma. Also, inert gas such as nitrogen may be used in the reacting space 312 in addition to the source gas. In the plasma device 300, when the high-frequency power 333 applies electric power to the upper electrode 321 and the silane gas and the ammonia gas flow into the reacting space 312 through the inlets 313,314, respectively, plasma is formed in the reacting space 312 and silicon nitride is deposited on the TFT substrate 100.

Referring to FIG. 5f, the second passivation film 152 is formed on the first passivation film 151. The second passivation film 152 is made of silicon nitride and formed sequentially in the same plasma device 300 as the first passivation film 151 is formed. The second passivation film 152 is formed as following.

When the first passivation film 151 is almost formed, the flow rate of the silane gas or/and the ammonia gas is modified, or frequency of the electric power which the high-frequency power 330 applies to the upper electrode 321 is modified.

If the second passivation film 152 is formed by increasing the flow rate of the silane gas, the flow rate of the silane gas is increased 1.5 times˜3 times of one when the first passivation film 151 is formed. If the second passivation film 152 is formed by decreasing the flow rate of the ammonia gas, the flow rate of the ammonia gas is reduced 0.1 times˜0.5 times of one when the first passivation film 151 is formed. The second passivation film 152 may be formed by increasing the flow rate of the silane gas and reducing the flow rate of the ammonia gas at a time. The flow rates of the silane gas and the ammonia gas are controlled by flow controllers 331,341, respectively. If the second passivation film 152 is formed by reducing the frequency of the high-frequency power, the frequency is reduced 0.1 times˜0.5 times of one when the first passivation film 151 is formed.

The second passivation film 152 formed as above has a higher silicon content than the first passivation 151 and the resistivity thereof is sharply reduced. The inflow of the source gas and the frequency are modified in parallel.

Thereafter, the contact hole 171 is formed on the passivation films 151,152 to expose the drain electrode 143 and the pixel electrode 161,162 thereon to complete the TFT substrate 100. The pixel electrode cutting patterns 172, 173 are formed while the pixel electrode 161,162 is formed.

The color filter substrate 200 is manufactured by a conventional method. The common electrode cutting pattern 252 is formed while the common electrode 251 is formed. Then, the TFT substrate 100 is dispose opposite to the color filter substrate 200 and the liquid crystal layer 300 is interposed therebetween, thereby completing the LCD panel 10.

Although a few embodiments of the present invention have been shown and described, it will be appreciated by those skilled in the art that changes may be made in these embodiments without departing from the principles and spirit of the invention, the scope of which is defined in the appended claims and their equivalents. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A TFT substrate comprising:
a TFT comprising a drain electrode;
a first passivation film formed on the TFT;
a second passivation film formed on the first passivation film and having lower resistivity than the first passivation film; and
a pixel electrode formed on the second passivation film and comprising a first pixel area electrically connected to the drain electrode and a second pixel area electrically separated from the drain electrode and the first pixel area.

2. The TFT substrate according to claim 1, wherein a portion of the drain electrode overlaps with the second pixel area, having the first passivation film and the second passivation film therebetween.

3. The TFT substrate according to claim 1, wherein the first passivation film and the second passivation film are made of silicon nitride, and the second passivation film has a higher silicon content than the first passivation film.

4. The TFT substrate according to claim 1, wherein the resistivity of the second passivation film is 1/100˜ 1/1000 of the resistivity of the first passivation film.

5. The TFT substrate according to claim 1, wherein the resistivity of the second passivation film is 10¹¹ Ωcm˜10 ¹² Ωcm.

6. The TFT substrate according to claim 1, wherein a thickness of the first passivation film is 1000 Å˜3000 Å, and a thickness of the second passivation film is 100 Å˜500 Å.

7. A manufacturing method of a TFT substrate comprising:
forming a TFT comprising a drain electrode;
forming a first passivation film and a second passivation film having lower resistivity than the first passivation film, on the TFT sequentially; and
forming a pixel electrode on the second passivation film, the pixel electrode comprising a first pixel area electrically connected to the drain electrode and a second pixel area electrically separated from the drain electrode and the first pixel area.

8. The manufacturing method of the TFT substrate according to claim 7, wherein the second passivation film is formed by chemical vapor deposition of silicon source gas and nitrogen source gas.

9. The manufacturing method of the TFT substrate according to claim 7, wherein the first passivation film and the second passivation film are formed by chemical vapor deposition of silicon source gas and nitrogen source gas.

10. The manufacturing method of the TFT substrate according to claim 9, wherein the first passivation film and the second passivation film are formed successively.

11. The manufacturing method of the TFT substrate according to claim 10, wherein a flow rate of the silicon source gas of the forming the second passivation film is 1.5 times˜3 times of a flow rate of the forming the first passivation film.

12. The manufacturing method of the TFT substrate according to claim 10, wherein a flow rate of the nitrogen source gas of the forming the second passivation film is 0.1 times˜0.5 times of a flow rate of the forming the first passivation film.

13. The manufacturing method of the TFT substrate according to claim 10, wherein the first passivation film and the second passivation film are formed by a plasma enhanced chemical vapor deposition, and high-frequency power frequency of the forming the second passivation film is lower than high-frequency power frequency of the forming the first passivation film.

14. The manufacturing method of the TFT substrate according to claim 13, wherein the high-frequency power frequency of the forming the second passivation film is 0.1 times˜0.5 times of the high-frequency power frequency of the forming the first passivation film.

15. The manufacturing method of the TFT substrate according to claim 10, wherein the silicon source gas comprises silane gas, and the nitrogen source gas comprises ammonia gas.

16. The manufacturing method of the TFT substrate according to claim 9, wherein the silicon source gas comprises silane gas, and the nitrogen source gas comprises ammonia gas.

17. An LCD panel comprising:
a first substrate comprising a TFT having a drain electrode, a first passivation film formed on the TFT, a second passivation film formed on the first passivation film and having lower resistivity than the first passivation film, and a pixel electrode formed on the second passivation film and having a first pixel area electrically connected to the drain electrode and a second pixel area electrically separated from the drain electrode and the first pixel area;
a second substrate facing the first substrate; and
a liquid crystal layer disposed between the first substrate and the second substrate.

18. The LCD panel according to claim 17, wherein the second substrate comprises a common electrode where a common electrode cutting pattern is formed.

19. The LCD panel according to claim 17, wherein the liquid crystal layer is vertical alignment mode.

20. The LCD panel according to claim 17, wherein a discharging amount of the second pixel area is less than 20% of a charging amount thereof in one frame.

21. The LCD panel according to claim 17, wherein the charging amount of the second pixel area is discharged 90% or more within 500 ms when the electric power is off.
